(19) United States
(12) Patent Application Publication
(10) Pub. No.: US 2026/0134641 A1
(43) Pub. Date: May 14, 2026

(54) CONTROL DEVICE

(71) Applicant: CANON KABUSHIKI KAISHA, Tokyo (JP)

(72) Inventor: Kazuki HAMADA, Tokyo (JP)

(21) Appl. No.: 19/440,832

(22) Filed: Jan. 6, 2026

Related U.S. Application Data
(63) Continuation of application No. PCT/JP2024/015410, filed on Apr. 18, 2024.

(30) Foreign Application Priority Data
Jul. 26, 2023 (JP) 2023-121803

(51) Int. Cl. G06T 19/00; G06F 3/04815; G06F 3/04886; G06V 20/20; G06V 20/40

(52) U.S. Cl. CPC G06T 19/006; G06F 3/04815; G06F 3/04886; G06T 2200/24; G06V 20/20; G06V 20/40

(57) ABSTRACT

A control device includes a controller capable of performing control to display a video of a virtual space on a head mounted display, and performing control to display a text field for character input in the virtual space, and a detector configured to detect a character input device from a video of a real space, wherein in a case where a state is in a character input state in which the text field is displayed and the character input is possible, the controller performs control to display, in the virtual space, an image representing the detected character input device in the video of the real space, and even if the state is in the character input state, in a case where the character input device is not detected, the controller performs control to display the video of the real space on the head mounted display.

### CROSS-REFERENCE TO RELATED APPLICATIONS

This application is a Continuation of International Patent Application No. PCT/JP2024/015410, filed Apr. 18, 2024, which claims the benefit of Japanese Patent Application No. 2023-121803, filed Jul. 26, 2023, both of which are hereby incorporated by reference herein in their entirety.

### BACKGROUND

### Field of the Technology

The present disclosure relates to a control device, and more particularly, to a character input method when a head mounted display is worn.

### Description of the Related Art

In recent years, a technique called virtual reality (VR) in which a virtual space generated by a computer can be experienced as if it were real has become widespread. For example, a user can wear a head mounted display (HMD) on the head to experience (view) a virtual reality video. When the HMD is worn on the head of the user, the user's view is covered by the HMD. Therefore, it is possible to provide the user with video experience of a high sense of immersion.

The user can perform various tasks, for example, character input, while experiencing the virtual reality video using the HMD. In a conventional general method of inputting characters in a virtual space, a virtual keyboard generated by CG is displayed in the virtual space, and a user inputs characters by operating the virtual keyboard. However, since the virtual keyboard is a CG without physical entity and the user cannot obtain tactile sensation at the time of inputting characters, character input using the virtual keyboard deteriorates in input speed and accuracy as compared with character input using a physical keyboard in the real world. Therefore, it is desirable to be able to use a keyboard in the real world even in character input in a virtual space.

A method of visually recognizing an object in the real world in a virtual space is disclosed in Japanese Patent Laid-Open No. 2005-086328 and Japanese Patent Laid-Open No. 2020-042206. Japanese Patent Laid-Open No. 2005-086328 discloses a method in which, when external information matching information registered in advance is detected, the external information is displayed on a head mounted display. Japanese Patent Laid-Open No. 2020-042206 discloses a method in which an image obtained by capturing the periphery of a hand of a user in the real world is superimposed on and displayed in a virtual space.

However, in the method disclosed in Patent Literature 1, a keyboard in the real world is unnecessarily displayed, which may interfere with the user's sense of immersion. In the method disclosed in Patent Literature 2, when a keyboard in the real world is not around the hand of a user, the user cannot visually recognize the keyboard in the real world.

### SUMMARY

The present disclosure provides a technique to enable a user who experiences a virtual reality video to view a character input device (for example, a keyboard) in the real world at a desired timing.

A control device according to the present disclosure includes a controller capable of performing control to display a video of a virtual space on a head mounted display, and performing control to display a text field for character input in the virtual space, and a detector configured to detect a character input device from a video of a real space, the video being captured by an image sensor, wherein in a case where a state is in a character input state in which the text field is displayed and the character input is possible, the controller performs control to display, in the virtual space, an image representing the detected character input device in the video of the real space, and even if the state is in the character input state, in a case where the character input device is not detected, the controller performs control to display the video of the real space on the head mounted display.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram illustrating a configuration of a head mounted display.

FIG. 2 is a flowchart of processing of the head mounted display.

FIG. 3 is a flowchart of display control processing.

FIG. 4 is a schematic diagram illustrating a virtual space video.

FIG. 5 is a modification of a flowchart of the display control processing.

FIG. 6 is another modification of the flowchart of the display control processing.

### DESCRIPTION OF THE EMBODIMENTS

Hereinafter, embodiments of the present disclosure are described with reference to the drawings. Note that an example in which the present disclosure is applied to a head mounted display will be described, but a control device of the present disclosure may be a device separate from the head mounted display. For example, the control device of the present disclosure may be a personal computer (PC) connected to the head mounted display.

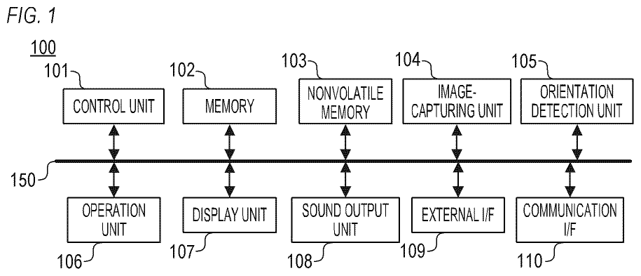

FIG. 1 is a block diagram illustrating a configuration of a head mounted display 100 according to the present embodiment. The head mounted display 100 includes a control unit 101, a memory 102, a nonvolatile memory 103, an image-capturing unit 104, an orientation detection unit 105, an operation unit 106, a display unit 107, a sound output unit 108, an external I/F 109, and a communication I/F 110. These units are connected to an internal bus 150 and can exchange data with each other via the internal bus 150.

The control unit 101 is formed of, for example, at least one processor or circuit and controls the entirety of the head mounted display 100. The memory 102 is, for example, a RAM (volatile memory using a semiconductor element). The nonvolatile memory 103 stores therein various data (information) such as image data, voice data, other data, and various programs for operating the control unit 101. The nonvolatile memory 103 is configured with, for example, a flash memory, a ROM, an HDD, or an SSD. The control unit 101 controls each unit of the head mounted display 100 using the memory 102 as a work memory according to, for example, a program stored in the nonvolatile memory 103.

The image-capturing unit 104 captures an image of the real space on the basis of the control of the control unit 101. As the image-capturing unit 104, an image-capturing element such as a CCD or a CMOS element that converts an optical image into an electrical signal can be used. Furthermore, a combination of a depth sensor configured to detect a physical distance of an object and an image-capturing element may be used as the image-capturing unit 104.

The orientation detection unit 105 detects the orientation of the head mounted display 100 with respect to the direction of gravity, and detects the inclination of the orientation with respect to each axis of yaw, roll, and pitch. It is possible to determine whether the head mounted display 100 is oriented upwards, downwards, or in an oblique orientation on the basis of the orientation detected by the orientation detection unit 105. As the orientation detection unit 105, at least one of an acceleration sensor, a gyro sensor, a geomagnetic sensor, an orientation sensor, and an altitude sensor can be used, and two or more thereof can be used in combination.

The operation unit 106 is an input device for receiving a user operation, and includes at least one of a pointing device such as a mouse or a touch panel, a button, a dial, a joystick, a touch sensor, and a touch pad. The operation unit 106 may be a device (for example, a controller or a keyboard) different from the head mounted display 100. In this case, communication with the operation unit 106 is performed using the communication I/F 110.

The display unit 107 displays various videos such as an image and a GUI screen constituting a graphical user interface (GUI) on the basis of the control of the control unit 101. The control unit 101 controls each unit of the head mounted display 100 to generate a display control signal according to a program, generate a video signal to be displayed on the display unit 107, and output the video signal to the display unit 107. The display unit 107 displays a video on the basis of the output video signal.

The sound output unit 108 outputs various sounds such as audio of a moving image or music data, an operation sound, a ring tone, and various notification sounds. The sound output unit 108 may be a speaker or an audio output terminal to which an earphone or the like is connected. The sound output unit 108 may be a communication unit that performs wireless communication with an external speaker or an earphone.

The external I/F 109 is an interface for connection to an external device via a cable or wirelessly and inputting and outputting at least one of a video signal and an audio signal to and from the external device. The communication I/F 110 is an interface for communicating with an external device or the Internet to perform transmission and reception of various data such as files and commands.

Note that the head mounted display 100 may be separated into a portion to be mounted on the head (head mounted display) and an external PC. In that case, for example, the display unit 107 is provided in the head mounted display, and the control unit 101 is provided in the external PC.

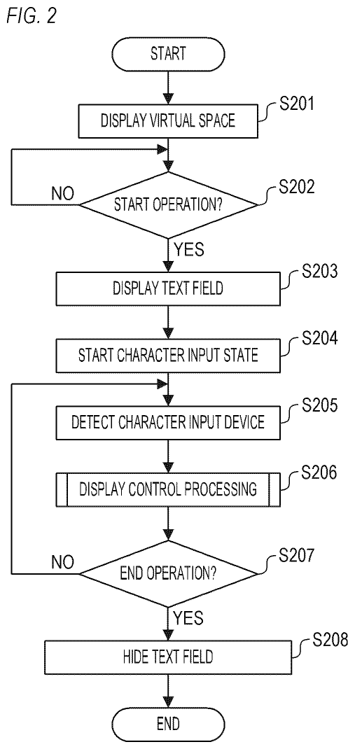

FIG. 2 is a flowchart of processing of the head mounted display 100. This processing is implemented by the control unit 101 configured to load a program stored in the nonvolatile memory 103 in the memory 102 and to execute the program. For example, when the head mounted display 100 is activated, the processing in FIG. 2 is started.

In S201, the control unit 101 displays a video of a virtual space on the display unit 107.

In S202, the control unit 101 determines whether a predetermined start operation for starting a character input state in which characters can be input has been performed. The processing waits until the start operation is performed, and when the start operation is performed, the processing proceeds to S203. For example, when a button for starting the character input state (a button for displaying a text field to be described later) is displayed in the virtual space and the button is operated using the operation unit 106, the processing proceeds to S203. The start operation is not limited thereto, and may be an operation on a button, a dial, a touch pad, or a mouse of the operation unit 106.

In S203, the control unit 101 displays a text field for character input in the virtual space displayed on the display unit 107.

In S204, the control unit 101 starts acceptance of character input into the displayed text field. As a result, the character input state is obtained.

In S205, the control unit 101 captures an image of the real space using the image-capturing unit 104, and detects a character input device from the captured real space (video of the real space). The character input device can be detected using various known techniques. The character input device is a device for inputting characters, and is, for example, a keyboard, a laptop, a smartphone, a tablet PC, or a touch pen. In the present embodiment, detection of the character input device is started in response to the character input state, but the present disclosure is not limited thereto. For example, the character input device may be detected regardless of whether the state is in the character input state. Detection of the character input device may be started in response to activation of the head mounted display 100.

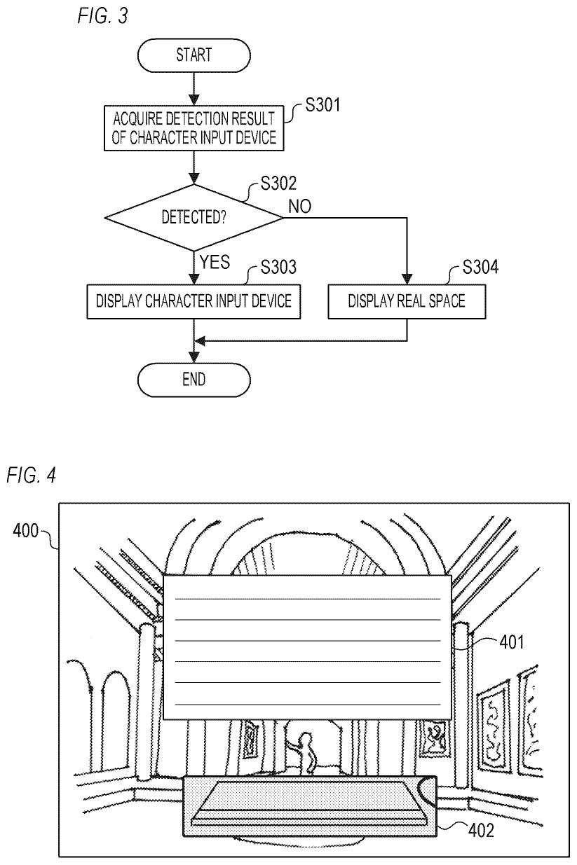

In S206, the control unit 101 controls the display on the display unit 107 (display control processing). Details of the display control processing will be described later with reference to FIG. 3. In the display control processing, for example, an image (input device image) representing the detected character input device is displayed in the virtual space.

In S207, the control unit 101 determines whether a predetermined end operation for ending the character input state has been performed. When the end operation has been performed, the processing proceeds to S208, and when the end operation has not been performed, the processing proceeds to S205. For example, when a button for ending the character input state (a button for hiding the text field) is displayed in the virtual space and the button is operated using the operation unit 106, the processing proceeds to S208. The end operation is not limited thereto, and may be an operation on a button, a dial, a touch pad, or a mouse of the operation unit 106, or may be an operation on an object that is not a text field.

In S208, the control unit 101 hides the text field. The user may be able to perform an operation to hide the input device image (non-display operation) using the operation unit 106, and the control unit 101 may hide the input device image while maintaining the character input state in response to the non-display operation. As a result, it is possible to temporarily hide the input device image in the middle of character input, and thus convenience is improved.

FIG. 3 is a flowchart of the display control processing performed in S206 of FIG. 2.

In S301, the control unit 101 acquires a detection result of the character input device (processing result in S205).

In S302, the control unit 101 determines whether the character input device has been detected according to the detection result of the character input device. When the character input device is detected, the processing proceeds to S303, and when the character input device is not detected, the processing proceeds to S304.

In S303, the control unit 101 calculates the position (coordinates) of the detected character input device in the real space (video of the real space) captured by the image-capturing unit 104. Then, the control unit 101 displays an image (input device image) representing the detected character input device at a position in the virtual space, which corresponds to the calculated position. Here, the input device image is an image obtained by cutting out a region corresponding to the detected position (coordinates) of the character input device from the video of the real space captured using the image-capturing unit 104. As a result, the user can visually recognize the input device image (character input device in the real world) and can suitably perform character input, and thus operability of character input is improved while a sense of immersion of the virtual space is obtained. The position of the character input device in the real space (real world) can be detected using various known techniques. The control unit 101 may change the display position of the text field to a position near the displayed input device image. This method shortens a movement amount of a line of sight between the input device image and the text field, so that the user can more suitably input characters.

In S304, the control unit 101 displays the video of the real space captured using the image-capturing unit 104 instead of the video of the virtual space displayed on the display unit 107 (with the video of the virtual space hidden). As a result, the user can easily find the character input device and input characters. The control unit 101 may display both the video of the virtual space and the video of the real space.

FIG. 4 is a schematic diagram illustrating a virtual space video 400 (a video of the virtual space) displayed on the head mounted display 100. The control unit 101 displays the virtual space video 400 on the display unit 107 (S201 in FIG. 2). When the user performs a predetermined operation while viewing the virtual space video 400, the control unit 101 displays a text field 401 in the virtual space (S203). For example, when a button for displaying the text field 401 is displayed in the virtual space and the button is operated using the operation unit 106, the text field 401 is displayed. The predetermined operation for displaying the text field 401 is not limited thereto, and may be an operation on a button, a dial, a touch pad, or a mouse of the operation unit 106.

After displaying the text field 401, the control unit 101 starts acceptance of character input into the text field 401 (S204). The acceptance of the character input into the text field 401 may be automatically started at the same time as the display of the text field 401, or may be started in response to an operation performed on the text field 401 by the user using the operation unit 106.

After starting to accept the character input into the text field 401, the control unit 101 starts to detect the character input device. The control unit 101 captures an image of the real space using the image-capturing unit 104, and detects the character input device from the captured real space (video of the real space) (S205). When detecting the character input device, the control unit 101 calculates the position of the detected character input device in the real space captured by the image-capturing unit 104. Then, the control unit 101 displays an image (input device image) 402 representing the detected character input device at a position in the virtual space, which corresponds to the calculated position (S303 in FIG. 3). The input device image 402 is an image obtained by capturing an image of the detected character input device. The control unit 101 extracts a rectangular region including the detected character input device from the video of the real space captured using image-capturing unit 104, and displays the extracted rectangular region as the input device image 402. Note that the control unit 101 may detect an outline of the character input device, may extract a region surrounded by the outline, and may display the region as the input device image. The control unit 101 may replace a three-dimensional model (3DCG) corresponding to the detected character input device with the input device image and may display the input device image.

As described above, according to the present embodiment, the user experiencing the virtual reality video can visually recognize the character input device (for example, a keyboard) in the real world at a desired timing. For example, when the state is not a character input state in which characters can be input into the text field, the input device image representing the detected character input device is not displayed in the virtual space, and when the state is the character input state, the input device image is displayed in the virtual space. As a result, in a case where character input is not performed, the input device image is not displayed, and thus the user's sense of immersion is not disturbed by the input device image. On the other hand, when character input is performed, the input device image is displayed, so that the user can visually recognize the input device image (character input device in the real world) and can suitably perform character input.

### First Modification

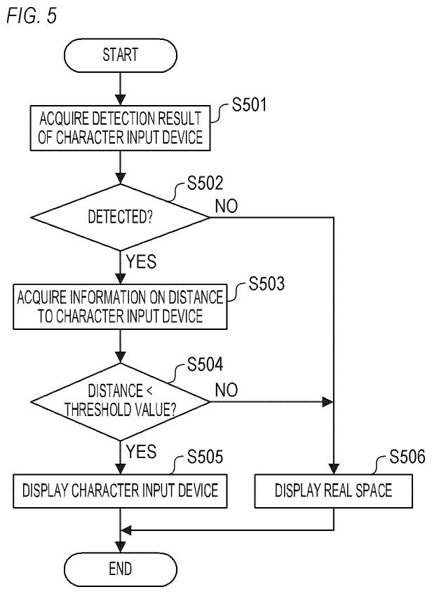

FIG. 5 is a modification of the flowchart of the display control processing performed in S206 of FIG. 2. In the display control processing of FIG. 5, a distance from the head mounted display 100 to the detected character input device is considered.

In S501, the control unit 101 acquires a detection result of the character input device (processing result in S205).

In S502, the control unit 101 determines whether the character input device has been detected according to the detection result of the character input device. When the character input device is detected, the processing proceeds to S503, and when the character input device is not detected, the processing proceeds to S506.

In S503, the control unit 101 acquires information (distance information) on a distance to the detected character input device from the head mounted display 100. The distance information can be acquired using various known techniques, and can be acquired using, for example, the image-capturing unit 104.

In S504, the control unit 101 determines whether the distance from the head mounted display 100 to the character input device is shorter than a threshold value (a predetermined distance) according to the acquired distance information. When the distance is shorter than the threshold value, the processing proceeds to S505, and when the distance is not shorter than the threshold value, the processing proceeds to S506. When the distance is equal to the threshold value, the processing proceeds to S506, but the processing may proceed to S505.

In S505, the control unit 101 calculates the position (coordinates) of the detected character input device in the real space (video of the real space) captured by the image-capturing unit 104. Then, the control unit 101 displays an image (input device image) representing the detected character input device at a position in the virtual space, which corresponds to the calculated position. The position of the character input device in the real space (real world) can be detected using various known techniques.

In S506, the control unit 101 displays the video of the real space captured using the image-capturing unit 104 instead of the video of the virtual space displayed on the display unit 107 (with the video of the virtual space hidden). The control unit 101 may display an item indicating the position of the detected character input device by superimposing the item on the video of the real space. As a result, when performing character input, the user can easily find the character input device from the video of the real space and can approach the character input device.

In a case where the distance from the head mounted display 100 to the character input device is long, the user needs to approach the character input device when inputting characters. Therefore, it is preferable that the user can grasp the surroundings. Therefore, in the first modification described above, in a case where the distance from the head mounted display 100 to the character input device is longer than the threshold value, the video of the real space is displayed without displaying the character input image. As a result, the user is allowed to easily approach the character input device while avoiding surrounding obstacles.

### Second Modification

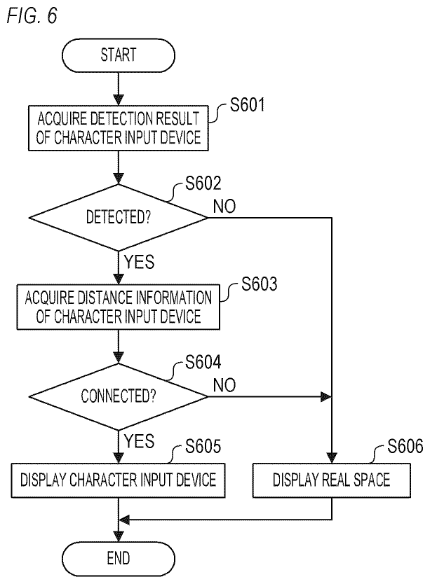

FIG. 6 is another modification of the flowchart of the display control processing performed in S206 of FIG. 2. In the display control processing of FIG. 6, a connection state of the detected character input device is considered.

In S601, the control unit 101 acquires a detection result of the character input device (processing result in S205).

In S602, the control unit 101 determines whether the character input device has been detected according to the detection result of the character input device. When the character input device is detected, the processing proceeds to S603, and when the character input device is not detected, the processing proceeds to S606.

In S603, the control unit 101 acquires information (connection information) on the connection state of the detected character input device. For example, when the detected character input device is not connected to the head mounted display 100, the connection information is not acquired, and when the detected character input device is connected to the head mounted display 100, the connection information is acquired using the communication I/F 110.

In S604, the control unit 101 determines whether the detected character input device is connected to the head mounted display 100 (in a wired or wireless manner) according to the acquisition result of the connection information. When the detected character input device is connected to the head mounted display 100, the processing proceeds to S605, and when the detected character input device is not connected to the head mounted display 100, the processing proceeds to S606.

In S605, the control unit 101 calculates the position (coordinates) of the detected character input device in the real space (video of the real space) captured by the image-capturing unit 104. Then, the control unit 101 displays an image (input device image) representing the detected character input device at a position in the virtual space, which corresponds to the calculated position. The position of the character input device in the real space (real world) can be detected using various known techniques.

In S606, the control unit 101 displays the video of the real space captured using the image-capturing unit 104 instead of the video of the virtual space displayed on the display unit 107 (with the video of the virtual space hidden). The control unit 101 may display a guidance prompting connection of the character input device to the head mounted display 100 by superimposing the guidance on the video of the real space. As a result, the user can easily recognize that the connection of the character input device is necessary. The control unit 101 may superimpose and display a list of character input devices (paired character input devices) connectable to the head mounted display 100 on the video of the real space. In this way, the user can easily select the paired character input device and can connect the selected character input device to the head mounted display 100.

In a case where the character input device is not connected to the head mounted display 100, the user needs to connect the character input device to the head mounted display 100 when inputting characters. Therefore, it is preferable that the user can grasp the surroundings. Therefore, in the second modification described above, when the detected character input device is not connected to the head mounted display 100, the video of the real space is displayed without displaying the character input image. As a result, the user can easily perform an operation (manipulation) of connecting the character input device to the head mounted display 100 while visually recognizing the operation.

Note that the above-described various types of control may be processing that is carried out by one piece of hardware (e.g., processor or circuit), or otherwise. Processing may be shared among a plurality of pieces of hardware (e.g., a plurality of processors, a plurality of circuits, or a combination of one or more processors and one or more circuits), thereby carrying out the control of the entire device.

Also, the above processor is a processor in the broad sense, and includes general-purpose processors and dedicated processors. Examples of general-purpose processors include a central processing unit (CPU), a micro processing unit (MPU), a digital signal processor (DSP), and so forth. Examples of dedicated processors include a graphics processing unit (GPU), an application-specific integrated circuit (ASIC), a programmable logic device (PLD), and so forth. Examples of PLDs include a field-programmable gate array (FPGA), a complex programmable logic device (CPLD), and so forth.

The embodiment described above (including variation examples) is merely an example. Any configurations obtained by suitably modifying or changing some configurations of the embodiment within the scope of the subject matter of the present disclosure are also included in the present disclosure. The present disclosure also includes other configurations obtained by suitably combining various features of the embodiment.

According to the present disclosure, a user who experiences a virtual reality video can view a character input device (for example, a keyboard) in the real world at a desired timing.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. A control device comprising:
a controller capable of performing control to display a video of a virtual space on a head mounted display, and performing control to display a text field for character input in the virtual space; and
a detector configured to detect a character input device from a video of a real space, the video being captured by an image sensor, wherein
in a case where a state is in a character input state in which the text field is displayed and the character input is possible, the controller performs control to display, in the virtual space, an image representing the detected character input device in the video of the real space, and
even if the state is in the character input state, in a case where the character input device is not detected, the controller performs control to display the video of the real space on the head mounted display.

2. The control device according to claim 1, wherein
the controller performs control to display the image representing the detected character input device at a position in the virtual space, the position corresponding to a position of the character input device in the real space.

3. The control device according to claim 1, wherein
the image representing the detected character input device is an image of a region corresponding to a position of the detected character input device in the video of the real space.

4. The control device according to claim 1, wherein
the image representing the detected character input device is a three-dimensional model corresponding to the detected character input device.

5. The control device according to claim 1, wherein
the controller performs control to hide the image representing the detected character input device in response to a predetermined operation of ending the character input state.

6. The control device according to claim 5, wherein
the predetermined operation is an operation on an object which is not the text field.

7. The control device according to claim 1, wherein
in a case where the image representing the detected character input device is displayed, the controller changes a display position of the text field to a position near the image.

8. The control device according to claim 1, wherein
in response to an operation of hiding the image representing the detected character input device, the controller performs control to hide the image representing the detected character input device while maintaining the character input state.

9. The control device according to claim 1, wherein
in a case where the state is not in the character input state, the controller performs control not to display, in the virtual space, the image representing the detected character input device.

10. The control device according to claim 1, wherein
in a case where the state is in the character input state and the character input device is not detected, the controller performs control to hide the video of the virtual space and display the video of the real space on the head mounted display.

11. The control device according to claim 1, wherein
even if the state is in the character input state, in a case where a distance from the head mounted display to the detected character input device is longer than a threshold value, the controller performs control to display the video of the real space on the head mounted display without performing control to display the image representing the detected character input device in the virtual space.

12. The control device according to claim 11, wherein
in a case where the state is in the character input state and the distance is longer than the threshold value, the controller performs control to superimpose and display an item indicating a position of the character input device on the video of the real space.

13. The control device according to claim 1, wherein
even if the state is in the character input state, in a case where the detected character input device is not connected to the head mounted display, the controller performs control to display the video of the real space on the head mounted display without performing control to display the image representing the detected character input device in the virtual space.

14. The control device according to claim 13, wherein
in a case where the state is in the character input state and the detected character input device is not connected to the head mounted display, the controller performs control to superimpose and display a guidance for prompting connection of the character input device to the head mounted display on the video of the real space.

15. The control device according to claim 13, wherein
in a case where the state is in the character input state and the detected character input device is not connected to the head mounted display, the controller performs control to superimpose and display a list of character input devices connectable to the head mounted display on the video of the real space.

16. The control device according to claim 1, wherein
the detector starts detection of the character input device in response to the character input state.

17. The control device according to claim 1, further comprising
the image sensor.

18. A control method comprising:
performing control to display a video of a virtual space on a head mounted display;
performing control to display a text field for character input in the virtual space;
detecting a character input device from a video of a real space, the video being captured by an image sensor;
in a case where a state is in a character input state in which the text field is displayed and the character input is possible, performing control to display, in the virtual space, an image representing the detected character input device in the video of the real space; and
even if the state is in the character input state, in a case where the character input device is not detected, performing control to display the video of the real space on the head mounted display.

19. A non-transitory computer readable medium that stores a program, wherein the program causes a computer to execute a control method comprising:
performing control to display a video of a virtual space on a head mounted display;
performing control to display a text field for character input in the virtual space;
detecting a character input device from a video of a real space, the video being captured by an image sensor;
in a case where a state is in a character input state in which the text field is displayed and the character input is possible, performing control to display, in the virtual space, an image representing the detected character input device in the video of the real space; and
even if the state is in the character input state, in a case where the character input device is not detected, performing control to display the video of the real space on the head mounted display.
